(19) United States
(12) Patent Application Publication
(10) Pub. No.: US 2010/0068376 A1
(43) Pub. Date: Mar. 18, 2010

(54) METHOD OF PREPARING COBALT AND LITHIUM ION-COATED NICKEL AND MANGANESE-BASED CATHODE MATERIAL

(75) Inventors: Mingfeng CHEN, Yuyao (CN); Jinhua HE, Yuyao (CN); Hanzhang ZHOU, Yuyao (CN)

Correspondence Address: MATTHIAS SCHOLL, 14781 MEMORIAL DRIVE, SUITE 1319, HOUSTON, TX, 77079, US

(73) Assignee: NINGBO JINHE NEW MATERIALS CO., LTD., Yuyao (CN)

(21) Appl. No.: 12/561,279

(22) Filed: Sep. 17, 2009

(30) Foreign Application Priority Data
Sep. 17, 2008 (CN) 200810121031.7

(51) Int. Cl. B05D 5/12

(52) U.S. Cl. 427/123

(57) ABSTRACT

A method of preparing a cobalt and lithium ion-coated nickel and manganese-based cathode material, including at least: (a) coating a layer of cobalt hydroxide on a substrate of Ni_{0.5}Mn_{0.5}(OH)₂ to yield y(Ni_{0.5}Mn_{0.5}(OH)₂)·(1-y)(Co(OH)₂) (0.2≦y≦0.8), (b) adding Lithium, and (c) sintering at 750-1000° C. for 8-24 hrs to yield LiNi_{0.5-x}Co₂ₓMn_{0.5-x}O₂ (0.03<x≦0.4). The method is easy for practice and suitable for mass production, and the cathode material prepared by the method, i.e., LiNi_{0.5-x}Co₂ₓMn_{0.5-x}O₂ (0.03<x≦0.4) features high specific capacity, stable cycle performance, and low cost.

### CROSS-REFERENCE TO RELATED APPLICATIONS

Pursuant to 35 U.S.C. §119 and the Paris Convention Treaty, this application claims priority benefits to Chinese Patent Application No. 200810121031.7 filed on Sep. 17, 2008, the contents of which are incorporated herein by reference.

### BACKGROUND OF THE INVENTION

1. Field of the Invention

The invention relates to a method of preparing a cobalt and lithium ion-coated nickel and manganese-based cathode material.

2. Description of the Related Art

Late last century, Sony Corp. (Japan) successfully developed lithium-ion batteries, which aroused widespread concern around the world. Due to its advantages such as high working voltage, small size, no memory effect, long cycle life, etc., lithium-ion batteries have begun to replace conventional rechargeable batteries including lead-acid batteries, nickel-cadmium batteries, and nickel-hydrogen batteries gradually. The research and development on cathode materials is significantly important for preparation of lithium-ion batteries. Nowadays, widely-used cathode materials mainly include LiCoO₂, LiNiO₂, LiNi₁₋ₓCoO₂, LiMnO₂, and LiMn₂O₄. Commercialized cathode materials for Lithium-ion batteries include LiCoO₂, LiNi_{1/3}Co_{1/3}Mn_{1/3}O₂, LiNi_{0.4}Co_{0.2}Mn_{0.4}O₂, LiNi_{0.8}Co_{0.2}O₂, and LiMn₂O₄. LiCoO₂ has a good cycle performance and is easily synthesized, but on the other hand, it has a low reversible capacity, is expensive, and causes huge pollution. LiNiO₂ is cheap, causes little pollution, and has a high reversible capacity, but its synthesis is difficult and cycle performance is bad. For spinel-structured LiMn₂O₄, under high temperature, serious capacity fading occurs, as well as irreversible capacity loss regardless of charge or discharge.

Researcher Sha ju discloses that the specific capacity of LiNi_{0.5}Mn_{0.5}O₂ prepared by coprecipitation is up to 150 mA·h/g at a voltage range of 2.5-4.3 V. Kang discloses that, the addition of Al, Ti, or Co can improve the discharge capacity and conductivity of LiNi_{0.5}Mn_{0.5}O₂, particularly Co.

Up to now, there is no reports on the method of the invention for preparing a Ni—Mn based and cobalt and lithium ion-coated cathode material of LiNi_{0.5-x}Co₂ₓMn_{0.5-x}O₂ (0.03<x≦0.4).

### SUMMARY OF THE INVENTION

In view of the above-described problems, it is one objective of the invention to provide a method for preparing a cobalt and lithium ion-coated nickel and manganese-based cathode material that is cheap and has good electrical properties.

To achieve the above objectives, in accordance with one embodiment of the invention, provided is a method for preparing a cobalt and lithium ion-coated nickel and manganese-based cathode material that is cheap and has good electrical properties, the method comprising at least: (a) coating a layer of cobalt hydroxide on a substrate of Ni_{0.5}Mn_{0.5}(OH)₂ to yield y(Ni_{0.5}Mn_{0.5}(OH)₂)·(1-y) (Co(OH)₂) (0.2≦y≦0.8); (b) adding Lithium; and (c) sintering at 750-1000° C. for 8-24 hrs to yield LiNi_{0.5-x}Co₂ₓMn_{0.5-x}O₂ (0.03<x≦0.4).

Specifically, the method comprises the steps of:
a) preparing a cobalt salt solution with concentration of 0.1-3 mol/L;
b) preparing an alkaline solution with concentration of 1-10 mol/L;
c) preparing a complexing agent solution;
d) weighting the substrate of Ni_{0.5}Mn_{0.5}(OH)₂;
5) slowly adding the complexing agent solution into the cobalt salt solution, adjusting the pH value at 7-9, stirring, slowly adding the weighted substrate of Ni_{0.5}Mn_{0.5}(OH)₂, stirring, slowly adding the alkaline solution, adjusting the terminal pH value at 10-13, maintaining a reaction temperature at 30-80° C., stirring, and aging for 12-24 hrs, a molar ratio of the cobalt salt to the substrate of Ni_{0.5}Mn_{0.5}(OH)₂ being 1:9;
6) transferring a product obtained from 5) into a solid-liquid separator, washing a solid separated from the solid-liquid separator with deionized water until the pH value lower than 8, drying the solid in an oven at 80-120° C. to yield a cobalt-coated precursor of Ni_{0.5}Mn_{0.5}(OH)₂; and
7) adding Lithium according to a ratio of Li/(Ni+Mn+Co)=1.05:1 and sintering at 750-1000° C. for 8-24 hrs to yield LiNi_{0.5-x}Co₂ₓMn_{0.5-x}O₂ (0.03<x≦0.4).

In a class of this embodiment, the cobalt and lithium ion-coated nickel and manganese-based cathode material is LiNi_{0.45}Co_{0.1}Mn_{0.45}O₂.

In a class of this embodiment, the cobalt salt is cobalt sulfate, cobalt chloride, cobalt acetate, or cobalt nitrate.

In a class of this embodiment, the alkaline solution is sodium hydroxide or potassium hydroxide.

In a class of this embodiment, the complexing agent is ammonia, ammonium sulfate, ammonium chloride, or sodium citrate.

Advantages of the invention are summarized below:
1) the method of preparing a Ni—Mn based and cobalt and lithium ion-coated cathode material is easy for practice and suitable for mass production; and
2) the cathode material of LiNi_{0.5-x}Co₂ₓMn_{0.5-x}O₂ (0.03<x≦0.4) prepared by the method has a high specific capacity, stable cycle performance, high capacity, good cycle performance, and low cost.

### DETAILED DESCRIPTION OF THE EMBODIMENTS

For further illustrating the invention, examples detailing a method of preparing a cobalt and lithium ion-coated nickel and manganese-based cathode material are described below. It should be noted that the following examples are intended to describe and not to limit the invention.

### EXAMPLE 1

To a reactor (200 L), 100 L of 0.5 mol/L cobalt sulfate solution was added. Under strong stirring, 15 L of 5 mol/L ammonia was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 11. The resultant solution was aged for 12 hrs with stirring at 40° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{0.45}Co_{0.1}Mn_{0.45}O₂.

### EXAMPLE 2

To a reactor (200 L), 100 L of 1 mol/L cobalt chloride solution was added. Under strong stirring, 15 L of 5 mol/L ammonia was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 11. The resultant solution was aged for 12 hrs with stirring at 40° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{0.4}Co_{0.2}Mn_{0.4}O₂.

### EXAMPLE 3

To a reactor (200 L), 100 L of 1.5 mol/L cobalt chloride solution was added. Under strong stirring, 20 L of 5 mol/L ammonium chloride was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 11. The resultant solution was aged for 12 hrs with stirring at 40° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{1/3}Co_{1/3}Mn_{1/3}O₂.

### EXAMPLE 4

To a reactor (200 L), 100 L of 0.5 mol/L cobalt sulfate solution was added. Under strong stirring, 10 L of 5 mol/L ammonium sulfate was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 11. The resultant solution was aged for 12 hrs with stirring at 40° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{0.45}Co_{0.1}Mn_{0.45}O₂.

### EXAMPLE 5

To a reactor (200 L), 100 L of 0.5 mol/L cobalt sulfate solution was added. Under strong stirring, 15 L of 5 mol/L ammonia was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 11. The resultant solution was aged for 12 hrs with stirring at 60° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{0.45}Co_{0.1}Mn_{0.45}O₂.

### EXAMPLE 6

To a reactor (200 L), 100 L of 0.5 mol/L cobalt sulfate solution was added. Under strong stirring, 15 L of 5 mol/L ammonia was further added slowly by a peristaltic pump, and the pH value was adjusted at 8 or so. After that, the mixture was stirred for half an hour to yield a homogenous cobalt-ammonia complexing solution. To the complexing solution, 41.78 Kg of Ni_{0.5}Mn_{0.5}(OH)₂ was slowly added, stirred for an hour, and allowed to soak completely. Subsequently, 5 mol/L sodium hydroxide solution was added at a constant speed by a constant flow pump until the terminal pH value reached 10. The resultant solution was aged for 12 hrs with stirring at 30° C., extracted, washed, and dried in a thermostatic oven at 80° C. for 24 hrs to yield a cobalt-coated precursor of Ni_{0.5}Mn_{0.5}(OH)₂. Lithium was added according to a ratio of Li/(Ni+Mn+Co)=1.05:1 and sintered at 850° C. for 12 hrs to yield LiNi_{0.45}Co_{0.1}Mn_{0.45}O₂.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method of preparing a cobalt and lithium ion-coated nickel and manganese-based cathode material, comprising at least:
(a) coating a layer of cobalt hydroxide on a substrate of Ni_{0.5}Mn_{0.5}(OH)₂ to yield y(Ni_{0.5}Mn_{0.5}(OH)₂)·(1-y) (Co(OH)₂) (0.2≦y≦0.8);
(b) adding Lithium; and
(c) sintering at 750-1000° C. for 8-24 hrs to yield LiNi_{0.5-x}Co₂ₓMn_{0.5-x}O₂ (0.03<x≦0.4).

2. The method of claim 1, comprising the steps of:
a) preparing a cobalt salt solution with concentration of 0.1-3 mol/L;
b) preparing an alkaline solution with concentration of 1-10 mol/L;
c) preparing a complexing agent solution;
d) weighting said substrate of Ni_{0.5}Mn_{0.5}(OH)₂;
e) slowly adding said complexing agent solution into said cobalt salt solution, adjusting the pH value at 7-9, stirring, slowly adding said weighted substrate of Ni_{0.5}Mn_{0.5}(OH)₂, stirring, slowly adding said alkaline solution, adjusting the terminal pH value at 10-13, maintaining a reaction temperature at 30-80° C., stirring, and aging for 12-24 hrs, a molar ratio of said cobalt salt to said substrate of Ni_{0.5}Mn_{0.5}(OH)₂ being 1:9;
f) transferring a product obtained from e) into a solid-liquid separator, washing a solid separated from said solid-liquid separator with deionized water until the pH value lower than 8, drying said solid in an oven at 80-120° C. to yield a cobalt-coated precursor Ni_{0.5}Mn_{0.5}(OH)₂; and
g) adding Lithium according to a ratio of Li/(Ni+Mn+Co)=1.05:1 and sintering at 750-1000° C. for 8-24 hrs to yield LiNi_{0.5-x}Co₂ₓMn_{0.5-x}O₂ (0.03<x≦0.4).

3. The method of claim 2, wherein said cobalt and lithium ion-coated nickel and manganese-based cathode material is LiNi_{0.45}Co_{0.1}Mn_{0.45}O₂.

4. The method of claim 2, wherein said cobalt salt is cobalt sulfate, cobalt chloride, cobalt acetate, or cobalt nitrate.

5. The method of claim 2, wherein said alkaline solution is sodium hydroxide or potassium hydroxide.

6. The method of claim 2, wherein said complexing agent is ammonia, ammonium sulfate, ammonium chloride, or sodium citrate.
